(19) United States
(12) Patent Application Publication
(10) Pub. No.: US 2006/0142008 A1
(43) Pub. Date: Jun. 29, 2006

(54) Apparatus and method for handover in mobile communication system

(76) Inventors: Ji Cheol Lee, Yongin-si (KR); Dong Keon Kong, Suwon-si (KR); Sang Jun Moon, Yongin-si (KR); Sung Won Lee, Sungnam-si (KR); Sang Do Lee, Suwon-si (KR); Jong Bum Pyo, Yongin-si (KR); Eun Young Chung, Paldal-gu (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/250,625

(22) Filed: Oct. 17, 2005

(30) Foreign Application Priority Data
Oct. 15, 2004 (KR) 10-2004-0082860

(51) Int. Cl. H04Q 7/20

(52) U.S. Cl. 455/436

(57) ABSTRACT

An apparatus and method for a handover in a mobile communication system are provided. The handover apparatus includes an interface unit for setting a first path used before the handover and a second path used after the handover, for the mobile terminal undergoing the handover. A controller determines whether or not data to be transmitted to the mobile terminal is real-time data upon receipt of the data, transmits the data to the mobile terminal through the first and second paths when it is determined to be real-time data, and buffers the data and transmits the buffered data to the mobile terminal through the second path after completion of the handover when it is determined not to be real-time data. A buffer stores the buffered data until the handover is completed.

### CLAIM OF PRIORITY

This application makes reference to, incorporates the same herein, and claims all benefits accruing under 35 U.S.C. §119(a) from an application for APPARATUS AND METHOD FOR HANDOVER IN MOBILE COMMUNICATION SYSTEM filed in the Korean Intellectual Property Office on Oct. 15, 2004 and there duly assigned Serial No. 10-2004-0082860.

### BACKGROUND OF THE INVENTION

1. Field of the Invention

The present invention relates to an apparatus and method for handover in a mobile communication system. More specifically, the present invention relates to a handover apparatus and method capable of reducing the amount of data generated in a handover.

2. Description of the Related Art

A handover (also called a handoff) is significant technology generally used in a mobile communication system to change a radio channel in use. The handover transfers management of a mobile terminal between two radio base stations when the mobile terminal travels out of range of one base station and into range of the other base station. The radio base stations communicate with the mobile terminal via radio waves, and may be referred to by other names. By performing the handover, the mobile terminal can receive service without interruption even when traveling from one radio base station to another.

The handover will be described below with reference to the attached drawings.

FIG. 1 illustrates a case where the handover is performed in a mobile communication system.

First, a network shown in FIG. 1 will be described. FIG. 1 illustrates a 3GPP2 network, that is, a CDMA 2000 network. The mobile terminal 100 is connected to a radio network 110-1 or 110-2 through the radio frequency band. In particular, the radio network 110-1 to which the mobile terminal 100 belongs before traveling can be called a serving radio network, and the radio network 110-2 to which the mobile terminal 100 belongs after traveling can be called a target radio network. The radio network 110-1 or 110-2 connects the mobile terminal 100 with a packet data serving node (PDSN) 120-1 or 120-2. Specifically, the PDSN 120-1 to which the mobile terminal 100 belongs before traveling can be called a source PDSN, and the PDSN 120-2 to which the mobile terminal 100 belongs after traveling can be called a target PDSN. The radio network 110-1 or 110-2 can include a radio base station (not shown) and a base station controller/packet control function (BSC/PCF) (not shown). The BSC for transmitting voice data is not directly related to the present invention and therefore will not be mentioned hereinafter. The radio network 110-1 or 110-2 and the PDSN 120-1 or 120-2 allow the mobile terminal 100 to communicate data over a network such as the Internet.

The handover is performed when the mobile terminal 100 travels to an area managed by the radio network 110-2 and the PDSN 120-2 while performing data service through the radio network 110-1 and the PDSN 120-1. If the handover is performed as above, in the 3GPP2 network, the PDSN 120-1 managing the mobile terminal 100 before traveling is connected with the PDSN 120-2 managing the mobile terminal 100 after traveling, by tunneling. In other words, in the 3GPP2 network, the handover is performed using a path extension between the PDSNs 120-1 and 120-2 without changing the PDSN 120-1 providing a service to the mobile terminal 100, through tunneling. That is, after the handover, the mobile terminal 100 communicates data through the first PDSN 120-1, the second PDSN 120-2, and the second radio network 110-2. The first and second PDSNs 120-1 and 120-2 are connected through a tunnel.

The above handover is performed as described below, wherein the radio network 110-1 and the PDSN 120-1 managing the mobile terminal 100 before traveling are called a first radio network and a first PDSN, and the radio network 110-2 and the PDSN 120-2 managing the mobile terminal 100 after traveling are called a second radio network and a second PDSN.

If the mobile terminal 100 travels from the area managed by the first PDSN 120-1 to the area managed by the second PDSN 120-2, the second radio rietwork 110-2 detects the move and requests the second PDSN 120-2 to assign a RNN (radio network node)-PDSN (R-P) interface. The second radio network 110-2, specifically, its packet control function (PCF) (not shown), requests the second PDSN 120-2 to assign the R-P interface. When the second radio network 110-2 requests the second PDSN 120-2 to assign the R-P interface, it transmits given PDSN information, that is, information on the first PDSN 120-1, to the second PDSN 120-2.

The second PDSN 120-2 requested by the second radio network 110-2 to assign the R-P interface recognizes the handover of the mobile terminal 100 and requests the first PDSN 120-1 to set the P-P interface.

When the first PDSN 120-1 is requested by the second PDSN 120-2 to set the P-P interface, it creates a P-P tunnel with the second PDSN 120-2. The first PDSN 120-1 transmits data to the mobile terminal 100 through the P-P tunnel after the handover. However, the first PDSN 120-1 simultaneously transmits the data to the mobile terminal 100 through the given R-P interface with the first radio network 110-1 and the P-P tunnel depending on instructions indicated by an “S” (Simultaneous Binding) bit included in a message. In other words, the first PDSN 120-1 transmits the same data to the mobile terminal 100 through two paths.

In the handover of the mobile terminal 100, as described above, the first PDSN 120-1 transmits the same data to the mobile terminal 100 through two paths. This is to enhance the reliability of data transfer in the handover, because the mobile terminal 100 undergoing the handover is in transition from the first radio network 110-1 to the second radio network 110-2 and it cannot be guaranteed that the data will always be received from either one radio network 110-1 or 110-2.

As described above, the mobile terminal 100 undergoing the handover receives the same data through two paths, which wastes transmission resources including radio resources. Accordingly, there is a need for an improved handover apparatus and method that is more reliable and makes more efficient use of resources.

### SUMMARY OF THE INVENTION

It is, therefore, an objective of the present invention to provide a handover apparatus and method capable of reducing transmission resources used in a handover.

According to an aspect of the present invention, there is provided an apparatus for performing a handover of a mobile terminal in a mobile communication system. The apparatus includes an interface unit for setting a first path used before the handover and a second path used after the handover for the mobile terminal undergoing the handover. A controller determines whether or not data to be transmitted to the mobile terminal is real-time data upon receipt of the data, transmits the data to the mobile terminal through the first and second paths if it is determined to be real-time data, and buffers the data and transmits the buffered data to the mobile terminal through the second path after completion of the handover when it is determined not to be real-time data. A buffer stores the buffered data.

According to another aspect to the present invention, there is provided a method for performing a handover of a mobile terminal in a mobile communication system. The method includes receiving data to be transmitted to the mobile terminal undergoing the handover, from a core network. The received data is determined to be real-time data or not. The data is simultaneously transmitted to the mobile terminal through a first path used before the handover and a second path used after the handover if the data is real-time data. The data is buffered if the data is not real-time data. The buffered data is transmitted to the mobile terminal through the second path when the handover of the mobile terminal is completed.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 illustrates a case where a handover is performed in a mobile communication system;

FIG. 2 illustrates a construction of a handover apparatus according to an embodiment of the present invention;

FIG. 3A illustrates a construction of a handover apparatus according to an embodiment of the present invention;

FIG. 3B illustrates an example of a table used in the handover apparatus of FIG. 3A;

FIG. 4 is a flowchart illustrating a handover method according to an embodiment of the present invention;

FIG. 5 is a flowchart illustrating a handover method using a table according to an embodiment of the present invention;

FIG. 6 illustrates an example of a handover applied to a network according to an embodiment of the present invention; and

FIG. 7 illustrates an example of a handover applied to a network connecting a 3G network and a wireless LAN according to an embodiment of the present invention.

### DETAILED DESCRIPTION OF EXEMPLARY EMBODIMENTS

The present invention will now be described more fully with reference to the accompanying drawings, in which exemplary embodiments of the invention are shown. It should be recognized, however, that the invention may be embodied in different forms and should not be construed as limited to the exemplary embodiments set forth herein. Rather, these exemplary embodiments are provided so that this disclosure will be thorough and complete, and will fully convey the scope of the invention to those skilled in the art.

The embodiments described below employ a method for reducing the transmission of data through two paths in a handover in order to prevent waste of transmission resources. To this end, embodiments of the present invention employ a method for buffering data that does not require real-time transmission such as data download but rather requires stable transmission, and transmitting the buffered data to a mobile terminal through a path after completion of the handover of the mobile terminal. However, data requiring real-time processing such as Voice over Internet Protocol (VoIP) can be lost due to buffering and therefore this method cannot be used for such data. Accordingly, embodiments of the present invention are preferably able to determine whether or not received data is real-time data. In other words, in exemplary embodiments of the present invention, data requiring real-time processing is instantly transmitted to the mobile terminal through two paths as in a conventional method, and data not requiring real-time processing is buffered and transmitted to the mobile terminal through only one path after the handover is completed.

The present invention will now be described through an exemplary embodiment applied to a 3GPP2 network.

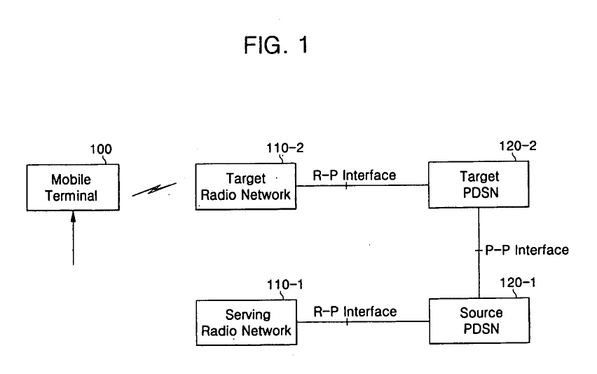

FIG. 1 illustrates a case where the handover is performed in a mobile communication system.

The mobile terminal 100 is connected to a radio network 110-1 or 110-2 through the radio frequency band. The radio network 110-1 or 110-2 connects the mobile terminal 100 and a PDSN 120-1 or 120-2. The radio network 110-1 or 110-2 can include a radio base station (not shown) and a packet control function (PCF) (not shown). The radio network 110-1 or 110-2 and the PDSN 120-1 or 120-2 allow the mobile terminal 100 to communicate data over the Internet. The radio network 110-1 or 110-2 and the PDSN 120-1 or 120-2 are connected through a R-P interface, and the PDSN 120-1 and 120-2 can be connected with each other using a PDSN-PDSN (P-P) interface.

The handover can be performed when the mobile terminal 100 travels to an area managed by the second radio network 110-2 and the second PDSN 120-2 while performing a data service through the first radio network 110-1 and the first PDSN 120-1. The mobile terminal 100 can be connected to the first PDSN 120-1 through two paths during the handover. One of the two paths is a path before the handover, having a sequence of the mobile terminal 100, the first radio network 110-1, and the first PDSN 120-1. The other is a path after the handover, having a sequence of the mobile terminal 100, the second radio network 110-2, the second PDSN 120-2, and the first PDSN 120-1. Hereinafter, the path before the handover is called the “first path” and the path after the handover is called the “second path”.

Upon completion of the handover, the mobile terminal 100 receives data through only the second path, but during the handover, the mobile terminal 100 can simultaneously receive data through both the first and the second paths. As shown in FIG. 1, the two paths start from the first PDSN 120-1. Therefore, an exemplary handover apparatus for determining whether to simultaneously transmit the data to the mobile terminal through two paths or to buffer the data, and then processing the data depending on the determination result, is preferably positioned at the first PDSN 120-1.

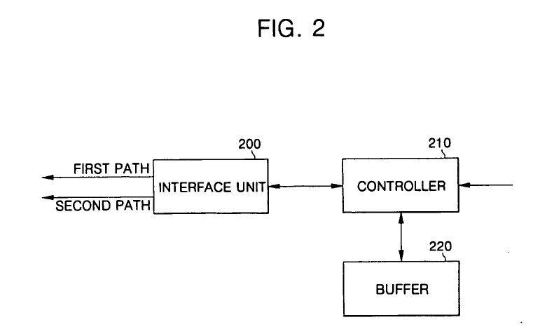

FIG. 2 illustrates a construction of the handover apparatus according to an embodiment of the present invention.

An exemplary handover apparatus comprises an interface unit 200, a controller 210, and a buffer 220.

The interface unit 200 creates a path for communicating data with the mobile terminal 100. The interface unit 200 can create the first path through the R-P interface with the first radio network 110-1 and can create the second path through the P-P interface with the second PDSN 120-2. The interface unit 200 can transmit the data to the mobile terminal 100 through the first and second paths.

The controller 210 processes the data. Upon receipt of the data, the controller 210 determines whether the received data is data to be transmitted to the mobile terminal 100 through the two created paths during the handover, such as real-time data, and processes the data depending on the determination result. In other words, the controller 210 instantly transmits the data to the mobile terminal 100 or buffers the data depending on the determination result. The controller 210 selects the transmission path of the data. When it is determined that the handover of the mobile terminal 100 is completed, the controller 210 transmits the buffered data to the mobile terminal 100 through the second path. The controller 210 can simultaneously transmit the data requiring instant transmission and real-time processing to the mobile terminal 100 through the first and second paths, and can transmit the buffered data to the mobile terminal 100 through only the second path.

The buffer 220 stores the buffered data.

As described above, embodiments of the present invention process data differently depending on whether or not it is real-time data, and therefore should be capable of determining whether or not the received data is real-time data. An example of determining whether or not the received data is real-time data will be described below with reference to the drawings.

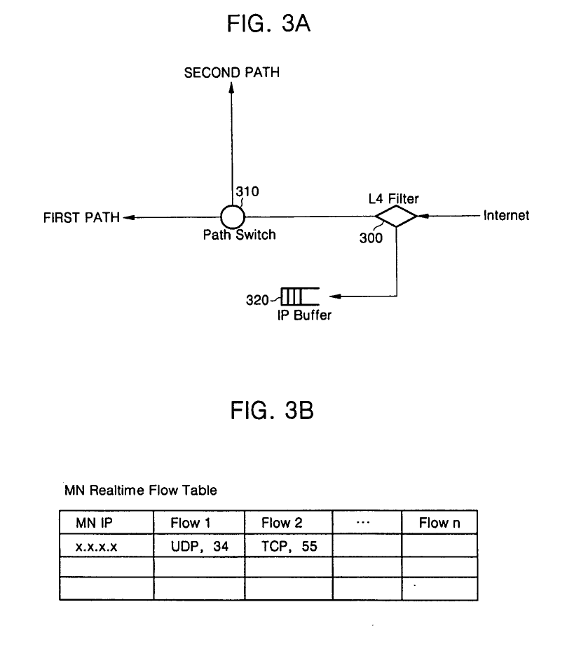

FIG. 3A illustrates the construction of a handover apparatus according to an exemplary embodiment of the present invention, and FIG. 3B illustrates an example of a table used in the handover apparatus of FIG. 3A.

As shown in FIG. 3A, the exemplary handover apparatus includes an L4 filter 300, a path switch 310, and a buffer 320.

The L4 filter 300 is a filter for confirming a four-level port to determine whether to buffer or transmit the received data. The L4 filter 300 can confirm the port with reference to a mobile node real-time flow table of FIG. 3B. The path switch 310 allows the data to be transmitted through the first path or the second path. The buffer 320 stores the data during the handover. In other words, it can be regarded that the L4 filter 300, the path switch 310, and the buffer 320 correspond to the controller 210, the interface unit 200, and the buffer 220 of FIG. 2, respectively.

The table of FIG. 3B is an example of a mobile node real-time flow table and includes four-level port information used by application programs in the mobile terminal 100. Meanwhile, as a method for setting up the mobile node real-time flow table; the following two methods can be considered. In the first method, when the handover is performed, the mobile terminal 100 informs the first PDSN 120-1 using a handover message. In the second method, when the first PDSN 120-1 performs a session initiation protocol (SIP) proxy function, it analyzes a real-time transport protocol (RTP) port number from a SIP message and registers the analyzed port number in the mobile node real-time flow table during a SIP-based VoIP service.

In other words, the L4 filter 300 can determine whether or not the received data is real-time data using the table of FIG. 3B, and output the received data to the path switch 310 or the buffer 320 depending on the determination result.

The handover apparatus of FIG. 3A can further include a storage unit (not shown) for storing the table of FIG. 3B.

An exemplary handover method corresponding to the handover apparatus will be described below.

Before the inventive handover method, a path creation process according to a handover procedure will be described.

When the mobile terminal 100 travels from an area of the first PDSN 120-1 to an area managed by the second PDSN 120-2, the second radio network 110-2 detects the move and requests the second PDSN 120-2 to assign the R-P interface. When the second radio network 110-2 requests the second PDSN 120-2 to assign the R-P interface, it transmits information on the first PDSN 110-1 to the second PDSN 120-2. Upon receipt of the request for assignment of the R-P interface from the second radio network 1110-2, the second PDSN 120-2 recognizes that the handover of the mobile terminal 100 is to be performed; and requests the P-P interface to be set to the first PDSN 120-1. Upon receipt of the request for setting the P-P interface from the second PDSN 120-2, the first PDSN 120-1 creates a P-P tunnel with the second PDSN 120-2, thereby creating the second path.

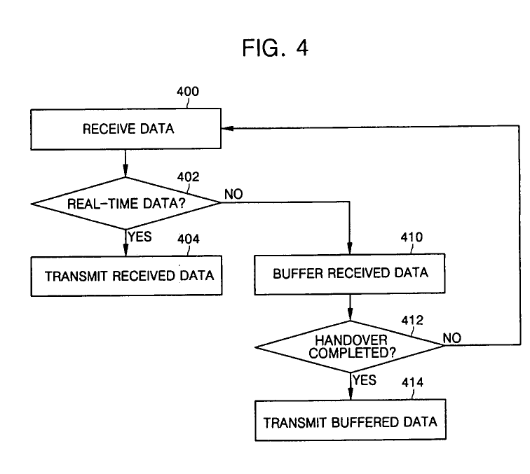

FIG. 4 is a flowchart illustrating the handover method according to an embodiment of the present invention.

In step 400, the exemplary handover apparatus receives data to be transmitted to the mobile terminal 100 through the two created paths during the handover. In step 402, the handover apparatus determines whether or not the received data is real-time data. If it is determined that the received data is real-time data, the handover apparatus simultaneously transmits the received data to the mobile terminal 100 through the first and second paths in step 404.

If it is determined that the received data is not real-time data, the handover apparatus buffers the received data in step 410. In step 412, the handover apparatus determines whether the handover is completed. If it is determined that the handover is completed, in step 414, the handover apparatus transmits the buffered data to the mobile terminal 100 through the second path.

Next, a an exemplary handover method corresponding to the handover apparatus of FIG. 3A will be described.

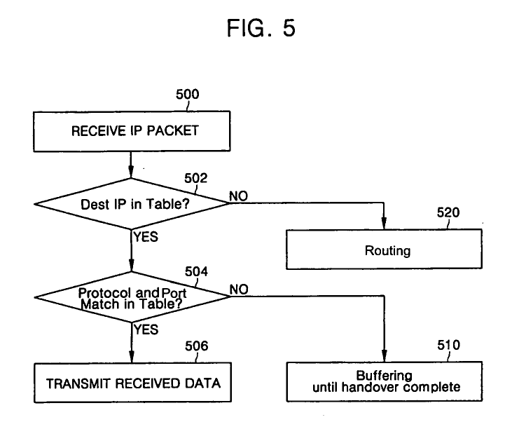

FIG. 5 is a flowchart illustrating the handover method using the table.

In step 500, the handover apparatus receives an Internet protocol (IP) packet to be transmitted to the mobile terminal 100. In step 502, the handover apparatus determines whether or not a destination address of the received IP packet is the managing IP address of the mobile terminal. If it is determined that the IP address is the destination address, in step 520, the handover apparatus transmits the IP packet to the mobile terminal corresponding to the destination address using a general IP routing function.

If it is determined in step 502 that the IP address is not the destination address, in step 504, the handover apparatus determines whether or not the destination address and a port of the IP packet are contained in the mobile node real-time flow table of FIG. 3B. If it is determined that the destination address and the port of the IP packet are contained in the mobile node real-time flow table, the handover apparatus determines that the IP packet is a packet requiring real-time processing, and simultaneously transmits the IP packet to the mobile terminal 100 through the first and second paths in step 506.

If it is determined in step 504 that the mobile node real-time flow table contains the destination address of the IP packet but not the port, the inventive handover apparatus determines that the IP packet is not a packet requiring real-time processing, and buffers the IP packet in step 510. The buffered IP packet is transmitted to the mobile terminal 100 through the second path used after the handover for the mobile terminal 100 is completed.

In the above exemplary embodiment of the present invention, the received data is classified as data requiring real-time processing and data not requiring real-time processing, and processed differently according to its classification. However, embodiments of the present invention can also operate based on other classifications. For example, in an exemplary handover apparatus, when the data has high priority, it can be transmitted through both paths, and when it has lower priority, it can be transmitted through only one path. In other words, upon receipt of data of a priority greater than a predetermined critical value, the handover apparatus simultaneously transmits the data through the two paths, and upon receipt of data of a priority less than the predetermined critical value, the handover apparatus transmits the data through only one of the two paths. In this example, buffering is not required. The exemplary handover apparatus can transmit data having a lower priority, even in the course of the handover, through only one path. The priority of the data can be determined using several means such as expression of the data significance.

An exemplary embodiment of the present invention will be described below with reference to the drawings.

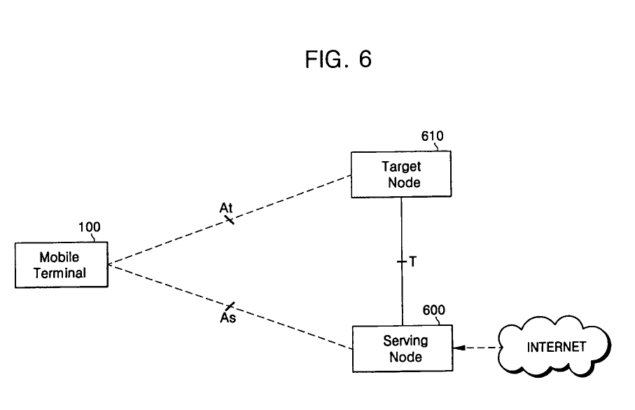

FIG. 6 illustrates an example of the handover applied to a network according to an embodiment of the present invention.

The mobile terminal 100 accomplishes the handover while moving from a serving node 600 (for example, a first IP router connecting the mobile terminal to an IP network) to a target node 610. The serving node 600 and the target node 610 can connect to the mobile terminal 100 using different interfaces. For example, it is assumed that the serving node 600 is connected with the mobile terminal 100 through an As interface, and the target node 610 is connected to the mobile terminal 100 through an At interface. In other words, the mobile terminal 100 has at least two radio connection interfaces, that is, the As interface and the At interface.

Further, it is assumed that the serving node 600 and the target node 610 are connected with each other through a T interface. The T interface can be defined as a tunnel for transmitting a control message for tunnel setting and data transmission between the serving node 600 and the target node 610, such as the P-P interface of the 3GPP2 network.

Embodiments of the present invention can also be applied in cases of networks connected using mutually different interfaces, in the same manner as the 3GPP2 network described as an example.

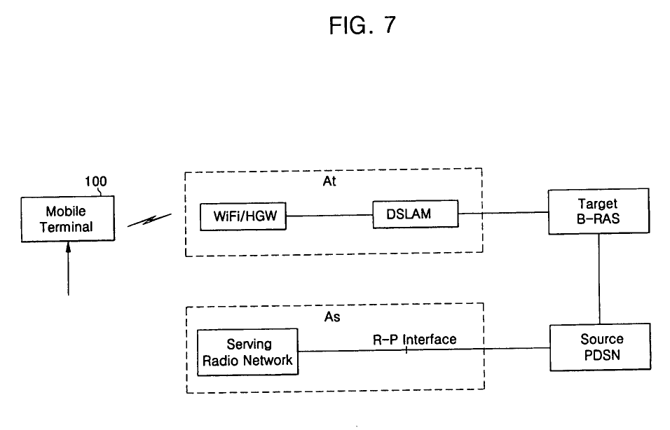

FIG. 7 illustrates an example of the handover applied to a network connecting a 3G network having mutually different interfaces and a wireless LAN according to an embodiment of the present invention. As shown the source radio network is embodied as a 3G network interface connected to a source PDSN. The target network is a WIFI network connected to a target B-RAS.

Thus, it should be appreciated that embodiments of the present invention can be applied to a wide variety of network configurations, including the network of FIG. 7.

As described above, in exemplary embodiments of the present invention, in the course of the handover, data is transmitted to the mobile terminal through only one path, not simultaneously through two paths, thereby effectively utilizing transmission resources during the handover.

Embodiments of the present invention can effectively utilize and reduce waste of transmission resources in the handover.

While the present invention has been described with reference to exemplary embodiments thereof, it will be understood by those skilled in the art that various changes in form and detail may be made therein without departing from the spirit and scope of the present invention as defined by the following claims.

What is claimed is:

1. An apparatus for performing a handover of a mobile terminal in a mobile communication system, the apparatus comprising:
an interface unit for setting a first path used before the handover and a second path used after the handover, for the mobile terminal undergoing the handover;
a controller for determining whether or not data to be transmitted to the mobile terminal is real-time data upon receipt of the data, transmitting the data to the mobile terminal through the first and second paths when it is determined to be real-time data, and buffering the data and transmitting the buffered data to the mobile terminal through the second path after completion of the handover when it is determined not to be real-time data; and
a buffer for storing the buffered data.

2. The apparatus according to claim 1, wherein the first path comprises of the mobile terminal, a radio network for managing the mobile terminal before the handover, and a packet data serving node (PDSN) for managing the mobile terminal before the handover, and the second path comprises the mobile terminal, a radio network for managing the mobile terminal after the handover, a PDSN for managing the mobile terminal after the handover, and a PDSN for managing the mobile terminal before the handover.

3. The apparatus according to claim 2, wherein in the second path, the PDSN after the handover and the PDSN before the handover are connected using a PDSN-PDSN (P-P) tunnel.

4. An apparatus for performing a handover of a mobile terminal in a mobile communication system, the apparatus comprising:
an L4 filter for receiving data to be transmitted to the mobile terminal undergoing the handover, and confirming a four-level port to determine whether to buffer the data and transmit the buffered data after completion of the handover of the mobile terminal, or to simultaneously transmit the data through both a first path used before the handover and a second path used after the handover, during the handover;
a buffer for storing the buffered data; and
a path switch for transmitting the data to the mobile terminal through the paths.

5. The apparatus according to claim 4, wherein the L4 filter determines whether or not to buffer the data with reference to a table having four-level port information of data used by the mobile terminal.

6. The apparatus according to claim 5, further comprising a storage unit for storing the table.

7. The apparatus according to claim 5, wherein when a destination address and a port of the received data are included in the table, the L4 filter simultaneously transmits the data through the first and second paths.

8. The apparatus according to claim 5, wherein when a destination address of the received data is included in the table but a port is not included in the table, the L4 filter buffers the data.

9. An apparatus for performing a handover of a mobile terminal in a mobile communication system, the apparatus comprising:
an interface unit for setting a first path used before the handover and a second path used after the handover, for the mobile terminal undergoing the handover; and
a controller for, upon receipt of data to be transmitted to the mobile terminal, determining a priority of the data, simultaneously transmitting the data to the mobile terminal through both the first and second paths if the data priority is greater than a predetermined critical value, and transmitting the data through only one of the two paths if the data priority is less than a predetermined critical value.

10. A method for performing a handover of a mobile terminal in a mobile communication system, the method comprising the steps of:
receiving data to be transmitted to the mobile terminal undergoing the handover;
determining whether or not the received data is real-time data;
simultaneously transmitting the data to the mobile terminal through a first path used before the handover and a second path used after the handover if the data is real-time data, and buffering the data when the data is not real-time data; and
transmitting the buffered data to the mobile terminal through the second path when the handover of the mobile terminal is completed.

11. A method for performing a handover of a mobile terminal in a mobile communication system, the method comprising the steps of:
receiving data to be transmitted to the mobile terminal undergoing the handover;
comparing a destination address and a port of the received data with a predetermined table, and determining whether or not the data requires real-time processing;
transmitting the data to the mobile terminal through first and second paths when the data requires real-time processing, and buffering the data when the data does not require real-time processing; and
transmitting the buffered data to the mobile terminal through the second path when the handover of the mobile terminal is completed.

12. The method according to claim 11, wherein the table has four-level port information used by the mobile terminal.

13. The method according to claim 12, wherein in comparing a destination address and a port of the received data with a predetermined table, and determining whether or not the data requires real-time processing, when the destination address and the port of the received data are included in the table, it is determined that the data requires real-time processing.

14. The method according to claim 12, wherein in comparing a destination address and a port of the received data with a predetermined table, and determining whether or not the data requires real-time processing, when the destination address of the received data is included in the table and the port is not included in the table, it is determined that the data does not require real-time processing.

15. A method for performing a handover of a mobile terminal in a mobile communication system, the method comprising the steps of:
receiving data to be transmitted to the mobile terminal undergoing the handover;
determining whether or not a priority of the received data is greater than a predetermined critical value; and
simultaneously transmitting the data through both a first path used before the handover and a second path used after the handover when the priority of the received data is determined to be greater than the predetermined critical value, and transmitting the data through only one of the two paths when the priority of the received data is determined to be less than the predetermined critical value.
